(19) United States
(12) Patent Application Publication
(10) Pub. No.: US 2013/0260734 A1
(43) Pub. Date: Oct. 3, 2013

(54) SYSTEMS, METHODS, AND COMPUTER PROGRAM PRODUCTS FOR DETECTING AND MANAGING CHANGES ASSOCIATED WITH MOBILE WALLETS

(71) Applicants: JVL VENTURES, LLC, New York, NY (US); CELLCO PARTNERSHIP D/B/A VERIZON WIRELESS, Basking Ridge, VA (US)

(72) Inventors: Manish Jain, Bangalore (IN); Kai P. Johnson, San Diego, CA (US); Syed M. Haider, Lilburn, GA (US); James Xanthos, Fulton, MD (US)

(73) Assignees: Cellco Partnership d/b/a Verizon Wireless, Basking Ridge, VA (US); JVL Ventures, LLC, New York, NY (US)

(21) Appl. No.: 13/782,876

(22) Filed: Mar. 1, 2013

Related U.S. Application Data
(60) Provisional application No. 61/619,480, filed on Apr. 3, 2012.

(51) Int. Cl. H04W 4/00

(52) U.S. Cl. CPC H04W 4/001
USPC 455/418

(57) ABSTRACT

System, methods, and computer program products are provided for detecting and managing changes associated with a mobile wallet. Current mobile wallet data is retrieved from at least one memory, and new mobile device attributes are retrieved. It is determined whether a change has occurred based on a comparison of the current mobile wallet data and the new mobile device attributes. A request to process a change is transmitted to a server on a communications network. Update data is received over the communications network, and the current mobile wallet data is updated in the at least one memory with the update data.

### CROSS REFERENCE TO RELATED APPLICATION

This application claims priority to U.S. Provisional Application No. 61/619,480, filed Apr. 3, 2012, the contents of which are incorporated herein by reference.

### BACKGROUND OF THE INVENTION

1. Field of the Invention

The present invention relates to detecting and managing changes in hardware and software, and more particularly to systems, methods, and computer program products for detecting and managing changes associated with mobile wallets.

2. Related Art

Mobile devices, such as mobile telephones or cellular phones, are increasingly being used as financial instruments to conduct commercial transactions. These transactions may be, for example, contactless transactions at a point of sale (POS) (or “check-out”) terminal. The ability to conduct commerce using mobile devices, known as mobile commerce, enables users to store, for example, credit, offer and loyalty card information on mobile devices and then utilize the mobile devices to conduct commercial transactions without needing, for example, a physical credit card, coupon, or loyalty card.

A mobile wallet is an application that enables a user to conduct transactions using a mobile device (e.g., via the user interface of the mobile device). Using the mobile wallet, users can manage their accounts, review offers, and initiate payments.

The mobile wallet controls the operation of the mobile device hardware, including a Near Field Communication (NFC) controller, an antenna, processor, memory, and a secure element (SE) and/or subscriber identity module (SIM) card in order to conduct the contactless transactions.

The NFC controller and antenna enable the mobile device to send account information securely to contactless payment readers at the POS. The controller and antenna also can be used to read contactless-enabled tags placed in consumer products or other locations (e.g., advertising displays).

The secure element stores and accesses account information and is generally considered secure because it is a self-contained system including a dedicated processor and memory that are protected by hardware and software hardening techniques that are verified by independent testing. Access to personal or financial account information (e.g., card information) in the secure element is protected by one or more security layers as well.

The mobile wallet may store or need to process information associated with a mobile wallet account, mobile device (e.g., device ID), user, mobile subscriber integrated services digital network-number (MSISDN) (i.e., mobile device number (MDN)), and/or mobile network operator (MNO), as well as payment, loyalty and/or offer card information. This information may be stored on a server, mobile device, and/or secure element.

Even though this configuration is generally deemed secure, storage of such sensitive data (i.e., personal and financial account information) on a mobile device can still benefit from additional security measures. In particular, while the mobile wallet or financial account information may remain the same, the mobile devices themselves might change, either purposely or accidentally. For example, mobile device users often replace or lose mobile devices, SIM cards, or secure elements. Mobile device users also change phone numbers or mobile network operators (MNOs) (also referred to as wireless network carriers). Moreover, mobile device users often lose data in mobile devices due to, for example, accidental deletion or resetting of a mobile device.

Due to the changes discussed above (e.g., lost, replaced, deleted or reset mobile device or secure element), mobile device users are faced with the overwhelming and time-sensitive task of recognizing that a change has occurred and taking the necessary steps to ensure that the mobile wallet is updated and functioning on their newest mobile device. For example, a user who loses his/her mobile device must (1) recognize a need to update, activate and/or restore the mobile wallet, (2) deactivate the mobile wallet on the lost mobile device, and (3) activate the mobile wallet on the new device. These actions require communicating with the mobile device, the MNO systems, the mobile wallet provider systems, the service provider (i.e., a company and/or entity issuing offers, loyalty, credit, debit, or rewards cards) systems, among others.

One technical challenge is the detection and management of such changes is the retrieval of mobile device data which may be stored on multiple systems (e.g., secure element, mobile device memory, remote server), and which must be analyzed before being used to detect and manage changes associated with mobile wallets. Storing, accessing or retrieving and using the mobile device data stored on various disparate systems requires complex coordination.

There is a need, therefore, for mechanisms and techniques that detect and manage changes, including hardware changes, associated with mobile wallets in mobile devices.

From the perspective of the user, what matters is that, when a change occurs, it is detected and managed relatively seamlessly (e.g., with little or no effort or input required by the user). That is, when the change occurs, the mobile wallet is easily activated on the user's most current mobile device, without the need for the user to take action and/or communicate with the MNO, service provider, and/or mobile wallet provider.

From the perspective of an MNO or a service provider, what matters is that mobile device information is readily stored and can be efficiently and effectively used to detect changes associated with a mobile wallet, and that the change can be managed (i.e., resolved) without overly burdening the MNO and/or service provider.

In other words, it would be useful to be able to securely and automatically detect changes associated with mobile wallets in mobile devices, and manage these changes, in order to ensure that a user's mobile wallet is always active and updated on the user's most updated mobile device.

### BRIEF DESCRIPTION OF THE INVENTION

The present invention provides systems, methods, and computer program products for detecting and managing changes associated with mobile wallets.

In one embodiment, a system for detecting and managing changes includes at least one memory coupled to a processor. The memory stores current mobile wallet data, including current mobile device attributes. Current mobile wallet data is retrieved from the at least one memory. New mobile device attributes are also retrieved. A determination is made as to whether a change has occurred based on a comparison of the current mobile wallet data and the new mobile device attributes. A request to process a change is transmitted to a server on a communications network. Update data is received over the communications network, and the current mobile wallet data is updated in the memory with the update data.

In another embodiment, a method for detecting and managing changes associated with a mobile wallet includes steps of: storing, in at least one memory, current mobile wallet data, including current mobile device attributes; retrieving the current mobile wallet data from the memory; retrieving new mobile device attributes; determining whether a change has occurred based on a comparison of the current mobile wallet data and new second mobile device attributes; transmitting, to a server on a communications network, a request to process the change; receiving, over the communications network, in response to the request, update data; and updating the current mobile wallet data in the memory with the update data.

In another embodiment, a non-transitory computer-readable medium stores sequences of instructions for causing one or more processors to: store, in at least one memory, current mobile wallet data, including current mobile device attributes; retrieve the current mobile wallet data from the at least one memory; retrieve new mobile device; determine whether a change has occurred based on a comparison of the current mobile wallet data and the new mobile device attributes; transmit, to a server on a communications network, a request to process the change; receive, over the communications network, in response to the request, update data; and update the current mobile wallet data in the memory with the update data.

In another embodiment, a system for detecting and managing changes includes at least one memory coupled to a processor. The memory stores current mobile wallet data, including current mobile device attributes. A request to process a change is received over a communications network. The request to process a change includes new mobile device attributes. At least a portion of the new mobile device attributes are validated. Based on a comparison between the new mobile device attributes and the current mobile device attributes, a change is determined. Update data is determined based on the change. An update request, including the update data, is transmitted to a mobile device over a communications network.

In another embodiment, a method for detecting and managing changes is provided. The method performs the steps of: receiving, over a communications network, a request to process a change, including new mobile device attributes; validating at least a portion of the new mobile device attributes; determining a change based on a comparison between the new mobile device attributes and current mobile device attributes, the current mobile device attributes being stored on at least one memory; determining, based on the change, update data; and transmitting an update request, including the update data, to a mobile device over a communications network.

In another embodiment, a non-transitory computer-readable medium stores sequences of instructions for causing one or more processors to: receive, over a communications network, a request to process a change, including new mobile device attributes; validate at least a portion of the new mobile device attributes; determine a change based on a comparison between the new mobile device attributes and current mobile device attributes, the current mobile device attributes being stored on at least one memory; determine, based on the change, update data; and transmit an update request, including the update data, to a mobile device over a communications network.

### BRIEF DESCRIPTION OF THE DRAWINGS

The features and advantages of the present invention will become more apparent from the detailed description set forth below when taken in conjunction with the following drawings.

FIG. 1 is a diagram of a system for adaptively managing changes associated with a mobile wallet in a mobile device according to an exemplary embodiment.

FIG. 2 is a flowchart illustrating a process for detecting changes associated with a mobile wallet during startup of the mobile wallet, according to an exemplary embodiment.

FIG. 3 is a flowchart illustrating a process for activating a mobile wallet on a mobile device according to an exemplary embodiment.

FIG. 4 is a flowchart illustrating a process for restoring a mobile wallet on a mobile device according to an exemplary embodiment.

FIG. 5 is a flowchart illustrating a process for validating changes associated with a mobile wallet according to an exemplary embodiment.

FIG. 6 is a block diagram of an exemplary system useful for implementing the present invention.

### DETAILED DESCRIPTION

### I. Overview

The example embodiments of the invention presented herein are directed to systems, methods, and computer program products for detecting and managing changes associated with mobile wallets in mobile devices. These changes may include, for example, changes in or to hardware and/or software in a mobile device, secure element communicatively coupled thereto (e.g., Universal Integrated Circuit Card (UICC), embedded SE, secure microSD, and the like), MSISDN, MNO, MNO provider, MNO account status, and/or any combination thereof.

The example embodiments of the invention presented herein are directed are described herein in terms of an example mobile wallet that determines whether the mobile device on which it is installed on is eligible to support the mobile wallet. This description is not intended to limit the application of the example embodiments presented herein. In fact, after reading the following description, it will be apparent to one skilled in the relevant art(s) how to implement the following example embodiments in alternative embodiments (e.g., a remote that upon receipt of an instruction, remotely checks whether the mobile device is eligible to support the mobile wallet).

Generally, upon opening a mobile wallet via a user interface of a mobile device, the mobile wallet itself determines whether the mobile device is eligible to support the mobile wallet. This determination is based on whether the mobile device meets predetermined criteria established by the mobile wallet issuer. If the mobile device is not eligible, the mobile wallet provides an indication to the user, such as by displaying an error message on the mobile device. If the mobile device is eligible, the mobile wallet retrieves mobile device attributes from the mobile device. The retrieved mobile device attributes vary depending on the model and/or type of mobile device, but may include, for example, a mobile device identifier (ID), SE ID, and SIM ID.

Once the mobile wallet retrieves the necessary mobile device attributes, the mobile wallet determines whether the mobile device includes a secure element. If the mobile device does not include a secure element, the mobile wallet provides an indication to the user, such as by displaying an error message on the mobile device. The mobile wallet then determines whether a mobile wallet record exists on the mobile device. A mobile wallet record is data that is associated with a mobile wallet, such as a mobile wallet ID. If a mobile wallet record does not exist on the mobile device, the mobile wallet presents options to equip the mobile device with new or preexisting mobile wallet data for provisioning the mobile wallet (i.e., mobile wallet and secure element data). These options, referred to as “resolution options” are presented to the user, for example, via a user interface of the mobile device, and may include options to activate or restore a mobile wallet.

In one embodiment, if a mobile wallet record exists on the mobile device, the mobile wallet determines whether the SE ID of the secure element matches the SE ID associated with the mobile wallet (i.e., stored in the mobile wallet). If the two SE IDs do not match, the mobile wallet presents resolution options to activate or restore a mobile wallet to the user via the user interface of the mobile device.

If the mobile wallet determines that the SE ID of the secure element matches the SE ID associated with the mobile wallet, then the mobile wallet retrieves its mobile wallet ID. The mobile wallet then checks whether it is suspended or pending activation. If a determination is made that the mobile wallet is suspended or pending activation, a notification message is communicated via the user interface of the mobile device.

If the mobile wallet has been suspended (i.e., the mobile wallet receives an error code of “SUSPENDED”), the mobile wallet may not be used to conduct payment transactions, but may be used to accept payments and/or credits to related accounts. Optionally, offers may be communicated as well. If the mobile wallet is pending activation (i.e., the status of the mobile wallet is “ACTIVATION PENDING”), the mobile wallet may not be used until the user activates it. If the mobile wallet is not pending activation or suspended, the mobile wallet proceeds to determine whether any changes have been made to or in the mobile wallet since the last time the mobile wallet was started.

In an exemplary embodiment, the mobile wallet determines whether the retrieved mobile device attributes are sufficient, based on predetermined criteria, to perform a parity check. If a determination is made that the retrieved mobile device attributes are sufficient to perform a parity check, the secure element performs the parity check to determine whether the device ID, mobile wallet ID, and/or SIM ID stored in the secure element match the device ID, mobile wallet ID, and/or SIM ID of the retrieved mobile device attributes. If a change associated with the mobile wallet has occurred, a mismatch is detected by the parity check. If the parity check passes (i.e., a mismatch is not detected), the mobile wallet may be started on the mobile device without any resolutions. If the parity check fails (i.e., a mismatch is detected), the mobile wallet presents resolution options to the user to activate or restore the mobile wallet.

A change associated with a mobile wallet may be automatically detected upon startup of the mobile wallet, and the change can be resolved with minimal processing and user interaction. The change may include a change of mobile device, secure element, MSISDN, MNO provider, MNO account status (e.g., suspension, termination), mobile wallet account service (e.g., issue, suspend, close), and/or any combination thereof.

### II. System

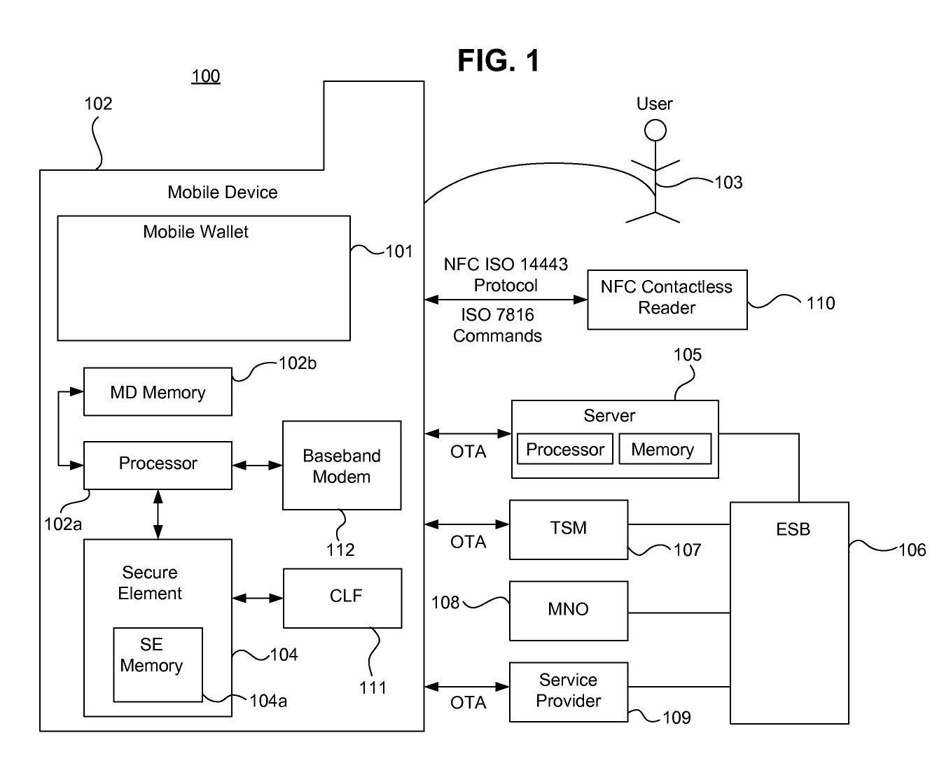

FIG. 1 is a diagram of a system for adaptively managing changes associated with a mobile wallet in a mobile device according to an exemplary embodiment. As shown in FIG. 1, system 100 includes a mobile device 102, a server 105, and an enterprise service bus (ESB) 106.

The mobile device 102 includes a mobile wallet 101, secure element 104, processor 102a, memory 102b (“MD Memory”), contactless frontend (CLF) 111, and baseband modem 112. The secure element 104 includes a memory 104a (“SE Memory”). The mobile device 102 may also include a user interface such as a display (not shown). A mobile wallet (e.g., mobile wallet 101) may be an application stored in, and associated with, a memory of a mobile device. The mobile wallet includes instructions which, when executed by the processor of a mobile device, cause the mobile device to act as an instrument, for example, for processing financial transactions or for processing commerce information such as offer or loyalty information. The mobile wallet and the secure element (e.g., secure element 104) may communicate using International Standards Organization (ISO) 7816 commands.

The mobile wallet stores attributes (in its associated memory (i.e., MD Memory 102b)) of an associated mobile wallet account, user, MSISDN, payment and loyalty cards and/or offers, which can be used to conduct a range of mobile commerce transactions. Additionally, a mobile wallet includes associated attributes which may be stored in one or more systems (e.g., server, mobile device, secure element, ESB, trusted service manager (TSM), etc.). Table 1 illustrates example attributes associated with a mobile wallet and the system or systems on which they may be stored, according to an exemplary embodiment.

TABLE 1
Examples of Mobile Wallet Attributes

| Attribute | Description | Storage Location |
|---|---|---|
| Mobile | Unique identifier of a mobile | Secure element; |
| Wallet ID | wallet having a mobile wallet | server; mobile |
| | account | device |
| Account | Username and password | Server |
| Credentials | combination associated with a | |
| | mobile wallet account | |
| Security | Question and answer combination | Server |
| Q & A | used for security of a mobile | |
| | wallet account | |
| Mobile | Unique identifier of a mobile | Secure element; |
| Device ID | device | server |
| SE ID | Unique identifier of a secure | Mobile device; |
| | element | server |
| MSISDN | Phone number or mobile network | Server |
| | line of service associated with | |
| | a mobile device | |
| SIM ID | Unique identifier of a SIM card on | Secure element; |
| | a mobile device | server |
| MNO | Unique identifier of a mobile | Server |
| | network operator of a mobile | |
| | device | |

Applets and/or applications stored on the mobile device provide a user interface for servicing operations associated with accounts. Such applets and/or applications are referred to as “widgets.” A widget may be associated with one or more instruments (e.g., payment and loyalty cards and/or offers). A widget may be, for example, a payment, offer, reward, or loyalty widget, and the like, and used by the mobile wallet to execute corresponding transactions.

In one embodiment, the secure element 104 also may be used to store applets and/or applications. The mobile wallet 101 communicates with the secure element 104 and uses the applets and/or applications on the secure element to conduct mobile transactions. The secure element 104 communicates with an NFC reader 110 (i.e., a contactless reader) using commands and protocols, such as ISO 7816 commands and NFC ISO 14443 protocol.

The baseband modem 112 is a digital modem that is used for mobile network communications. The CLF 111 is circuitry which handles the analogue part of NFC communications and the communication protocol layers of a contactless transmission link. The CLF 111 is also used to exchange data between the secure element 104 and the NFC reader 110. This allows the secure element to communicate with the NFC reader, for example, to conduct contactless mobile transactions.

The mobile device 102 includes attributes such as a device ID, SE ID, MSISDN, SIM ID, and MNO ID. A device ID may be an international mobile equipment identity (IMEI), a mobile equipment identifier (MEID), a Media Access Control (MAC) Address, or a similar unique serial number associated with hardware of a mobile device, and can be used to identify a change in the mobile device, such as whether a mobile device is lost or stolen. An SE ID may be a card image number (CIN), which is a unique number associated with an SE, and can be used, for example, to identify a change in an SE. An MSISDN may be a phone number associated with a mobile device line of service, which is associated with a user, and can be used, for example, to identify a change in a user's phone number. A SIM ID may be an integrated circuit card ID (ICCID) or an international mobile subscriber identity (IMSI), depending on the type of mobile device, and can be used, for example, to identify a change of SIM card. An MNO ID can be used to identify an MNO associated with a mobile device.

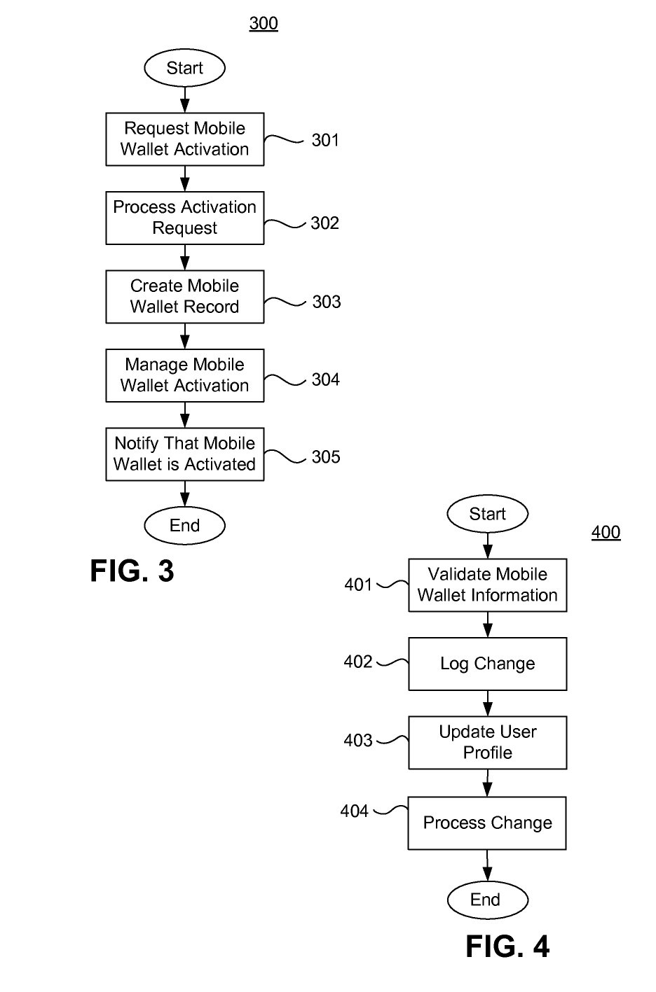

The mobile device 102 communicates with the server 105 over-the-air (OTA). The server 105 is coupled to the ESB 106 (described in further detail below with reference to FIG. 3), and may include a processor and memory. The ESB 106 is coupled to one or more TSMs (e.g., TSM 107), MNOs (e.g., MNO 108), and service provider systems (e.g., service provider 109). The TSM 107 communicates with the SE 104, and a service provider 109 communicates with the mobile wallet 101 using a communication standard such as OTA.

The TSM 107 securely provisions a virtual financial instrument onto a mobile wallet, for example, OTA. The TSM 107 manages communications between service providers and secure elements, activates a service on a secure element, receives financial account data from a user and, in turn, loads it into a mobile wallet, authenticates the account information with a financial institution, and then enables the necessary payment credentials that are used by the mobile wallet to conduct transactions. U.S. patent application Ser. No. 13/653,160, entitled “Systems, Methods, and Computer Program Products for Interfacing Multiple Service Provider Trusted Service Managers and Secure Elements,” which is incorporated herein by reference in its entirety, provides a central TSM for managing communications between service providers and secure elements.

### III. Process

A. Detecting Changes Associated with a Mobile Wallet During Startup of the Mobile Wallet

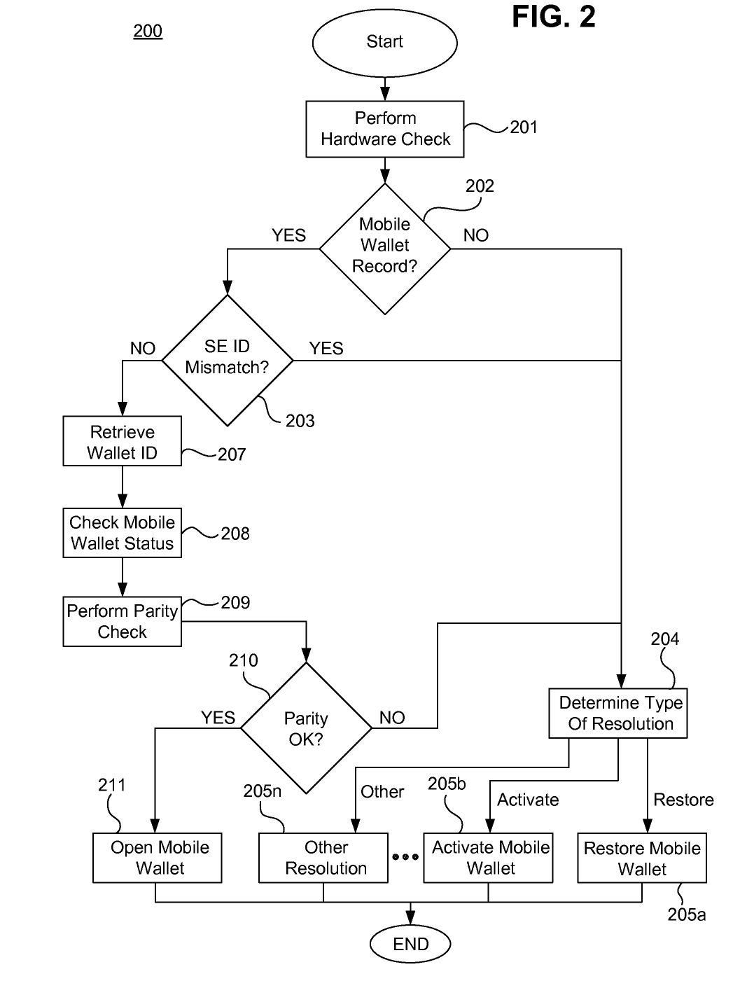

FIG. 2. is a flowchart illustrating a process 200 for detecting changes associated with a mobile wallet during startup of the mobile wallet, according to an exemplary embodiment.

A mobile wallet (e.g., mobile wallet 101) may be launched via a user interface of a mobile device (e.g., mobile device 102). For example, a user (e.g., user 103) may launch the mobile wallet 101 by selecting an icon on the display of the mobile device 102. As shown in FIG. 2, during the startup of the mobile wallet 101, a hardware check of the mobile device 102 is performed at block 201. In particular, the mobile wallet 101 first determines whether the mobile device 102 is eligible to support a mobile wallet. This determination is based on whether the mobile device 102 meets a predetermined criteria established by a mobile wallet issuer. Alternatively, the mobile wallet 101 checks whether the mobile device 102 exists on a predetermined list of eligible mobile devices stored in the mobile wallet 101. If the mobile wallet 101 determines, at block 201, that the mobile device 102 is not eligible to support a mobile wallet, it provides an indication to the user 103, such as by displaying an error message on the mobile device 102. If the mobile wallet 101 determines that the mobile device 102 is eligible to support a mobile wallet, the mobile wallet 101 retrieves mobile device attributes from the mobile device 102, including hardware information such as a device ID, an SE ID, and/or a SIM ID. The retrieved mobile device attributes may vary depending on the model and/or type of mobile device.

Once the mobile device attributes of the mobile device 102 have been retrieved, the mobile wallet 101 determines whether any attributes which the mobile wallet 101 attempted to retrieve from the mobile device 102 were not successfully retrieved (i.e., whether any mobile device attributes are missing). If the mobile wallet 101 determines that the expected attributes were not retrieved, the mobile wallet 101 specifically determines whether the retrieved mobile device attributes do not include a device ID and/or an SE ID. If a determination is made that a device ID and/or SE ID were not retrieved, the mobile wallet 101 provides an indication to the user 103, such as by displaying an error message on the mobile device 102.

The mobile wallet 101 may provide an indication to the user 103, such as by displaying an error message on the mobile device 102 if the retrieved mobile device attributes do not include expected attributes, based on the type of device. That is, the retrieved mobile device attributes that are expected may vary depending on the type of mobile device. For example, certain mobile devices do not include a SIM ID. Therefore, if the mobile wallet 101 determines that the mobile device 102 is of a type that does not include a SIM ID as one of its attributes, the mobile wallet 101 does not display an error message on the mobile device 102, and that attribute is not accounted for during a change management process. Alternatively, if the mobile device 102 is not of a type that includes a SIM ID, and a SIM ID is not retrieved in the mobile device attributes, the mobile wallet 101 provides an indication to the user, such as by displaying an error message on the mobile device 102.

If a determination is made that the attributes which the mobile wallet 101 attempted to retrieve from the mobile device 102 were successfully retrieved, the mobile wallet 101 determines whether the mobile device 102 includes a secure element. For example, the mobile wallet 101 can make this determination by attempting to establish a communication with a secure element in the mobile device 102. If the communication attempt fails, the mobile wallet 101 concludes that the mobile device 102 does not include a secure element. Alternatively, if the communication attempt succeeds, the mobile wallet 101 concludes that the mobile device 102 includes a secure element.

If the mobile wallet 101 determines that the mobile device 102 does not include a secure element, the mobile wallet 101 provides an indication to the user 103, such as by displaying an error message on the mobile device 102. If a determination is made that the mobile device 102 includes a secure element (e.g., secure element 104), then the mobile wallet 101 determines whether the secure element 104 is of a predetermined type of secure element based on the SE ID (e.g., CIN) of the secure element. If a determination is made that the secure element 104 is not of a predetermined type, then the mobile wallet 101 provides an indication to the user 103, such as by displaying an error message on the mobile device 102.

If the mobile wallet 101 determines that the secure element 104 is of a predetermined type (i.e., the secure element meets predetermined criteria), then the mobile wallet 101 determines at block 202 whether a mobile wallet record exists in the mobile device 102. A mobile wallet record is data that is associated with a mobile wallet, such as a mobile wallet ID. If a determination is made at block 202 that the mobile device 102 includes a mobile wallet record, the mobile wallet 101 determines, at block 203, whether the SE ID retrieved at block 201 (i.e., the SE ID of the secure element 104) matches the SE ID associated with the mobile wallet 101 (i.e., the SE ID stored in the mobile wallet 101).

Alternatively, if a determination is made, at block 202, that the mobile device 102 does not include a mobile wallet record, the mobile wallet 101 determines, at block 204, the appropriate type of resolution. The appropriate type of resolution may be determined based on a selection of one of a list of multiple resolution options. For example, a user (e.g., user 103) may input a selection via the user interface of the mobile device 102. The resolution options may include options to activate or restore a mobile wallet. If the mobile wallet determines at block 204 that the appropriate resolution is to activate a mobile wallet on the mobile device 102, the mobile wallet is activated at block 205b. Alternatively, if the mobile wallet 101 determines at block 204 that the appropriate resolution is to restore a mobile wallet on the mobile device 102, the mobile wallet is restored at block 206. Exemplary processes for activating and restoring a mobile wallet are discussed in further detail below with respect to FIGS. 3 and 4, respectively.

If the mobile wallet 101 determines at block 203 that the SE ID retrieved at block 201 (i.e., the SE ID of the secure element 104) does not match the SE ID associated with the mobile wallet 101 (i.e., the SE ID stored in the mobile wallet 101) (i.e., there is a mismatch), the mobile wallet 101 determines, at block 204, the appropriate type of resolution. The appropriate type of resolution may be determined based on a selection of one of a list of multiple resolution options. For example, a user may input a selection via the user interface of the mobile device 102. The resolution options may include options to activate or restore a mobile wallet on the secure element 104. Based on the resolution determined at block 204, a mobile wallet may be activated or restored at blocks 205b or 205a, respectively, as described above. Exemplary processes for activating and restoring a mobile wallet in a secure element are discussed in further detail below, with respect to FIGS. 3 and 4, respectively. In an alternative embodiment, the resolution options may include other resolutions, as shown in block 205n in FIG. 2.

If the mobile wallet determines, at block 203, that the SE ID retrieved at block 201 (i.e., the SE ID of the secure element 104) matches the SE ID associated with the mobile wallet 101 (i.e., the SE ID stored in the mobile wallet 101) (i.e., there is no mismatch), the mobile wallet 101 retrieves a mobile wallet ID associated with the mobile wallet 101, at block 207.

At block 208, the mobile wallet 101 checks its status (i.e., performs a status check). In particular, the mobile wallet 101 determines whether a mobile wallet companion applet (WCAp) on the secure element 104 is selectable on the mobile device 102. If a determination is made that the WCAp is not selectable, the mobile wallet 101 determines whether it is suspended by checking an error code transmitted by the WCAp. If the error code is “SUSPENDED,” the mobile wallet 101 provides an indication to the user 103 that it is suspended, for example, by displaying an error message on the mobile device 102. Alternatively, if the mobile wallet 101 determines that it is not suspended, the mobile wallet performs a check of its status to determine whether it is pending activation. If the mobile wallet status is “ACTIVATION PENDING” the mobile wallet 101 provides an indication to the user 103 that it is pending activation, for example, by displaying an error message on the mobile device 102.

In an alternative embodiment, at block 208, the secure element 104 determines whether a personal identification number (PIN) associated with the mobile wallet 101 is locked. If a determination is made that the PIN is locked, the mobile wallet 101 resets the PIN. In particular, to reset the PIN, the mobile wallet collects a user ID and password. The user ID and password may be collected, for example, via the user interface of the mobile device 102 and then validated with the server 105. If the user ID and password are validated, the mobile wallet 101 collects and stores a new PIN. The new PIN can be collected, for example, via the user interface of the mobile device 102.

In turn, if the status of the mobile wallet 101 was “ACTIVATION PENDING,” the mobile wallet 101 changes its status to “ACTIVE.”

At block 209, the secure element 104 performs a parity check. First, the mobile wallet 101 determines whether attributes necessary to perform a parity check are available. The attributes needed to perform a parity check may include an SE ID, mobile wallet ID, and/or SIM ID. In turn, at block 209, the secure element 104 performs the parity check. The parity check includes determining whether attributes, such as device ID, mobile wallet ID, and/or SIM ID, retrieved by the mobile wallet 101 match attributes stored on the secure element 104.

At block 210, the secure element 104 determines whether the parity check performed at block 209 passed. If the secure element 104 determines, at block 210, that the parity check performed at block 209 passed (i.e., attribute mismatches were not detected), the mobile wallet 101 sets a “Change Detected” flag to false. In turn, the mobile wallet 101 may be launched (i.e., opened) on the mobile device 102.

If the secure element 104 determines, at block 210, that the parity check performed at block 209 did not pass (i.e., one or more attributes mismatches were detected), the mobile wallet 101 sets the “Change Detected” flag to true. In turn, the mobile wallet 101 determines the appropriate type of resolution, at block 204. Determining the appropriate type of resolution is discussed above in further detail.

### B. Activating a Mobile Wallet on a Mobile Device

FIG. 3 is a flowchart illustrating a process 300 for activating a mobile wallet on a mobile device according to an exemplary embodiment.

At block 301, the mobile wallet 101 requests mobile wallet activation (i.e., activation of the mobile wallet 101 on the mobile device 102). In particular, at block 301, the mobile wallet 101 collects account credentials associated with the mobile wallet 101. The account credentials are collected, for example, from the user 103 via a user interface of the mobile device 102. Account credentials include, for example, a unique user name and password combination such as an e-mail and password set.

In an alternative embodiment, other device specific credentials may be collected as well, for example, the phone number or MSISDN of the mobile device associated with the mobile wallet.

In turn, the mobile wallet 101 determines whether terms of service (ToS) for using the mobile wallet 101 have been accepted. Terms of service are accepted, for example, by the user 103 via the mobile device 102. The mobile wallet 101 will continue to check whether the ToS have been accepted until it determines that they have been.

If the mobile wallet 101 determines that the ToS have been accepted, the mobile wallet 101 collects a PIN, for example, from the user 103 via a user interface of the mobile device 102. The collected PIN is then set as the PIN associated with the mobile wallet 101.

In turn, the mobile wallet 101 retrieves hardware information (i.e., mobile device attributes) necessary to transmit an activation request, which may include a device ID, SE ID, and/or SIM ID of the mobile device 102. Table 2 illustrates example parameters defining an activation request and whether they are required.

TABLE 2
Examples of Activation Request Parameters

| Parameter | Description | Required |
|---|---|---|
| Default | Indicates the regional (e.g., United | No |
| Locale | States) language, metrics, and stan- | |
| | dards to use in a mobile wallet | |
| Network | Indicates the type of mobile network | Yes |
| Type | of a mobile device | |
| Device | Unique identifier of a mobile device | Yes |
| ID | (e.g., IMEI, MEID, MAC Address) | |
| Application | Application identifier used for | No |
| ID | pushing information onto mobile | |
| | device | |
| SE ID | Unique identifier of a secure | Yes |
| | element (e.g., CIN) | |
| MNO Name | Name of mobile network operator of | Yes |
| | a mobile device | |
| Device | Name of manufacturer of a mobile | Yes |
| Manufacturer | device | |
| Password | User-inputted password associated | Yes |
| | with a mobile wallet | |
| SE_Changed | Indicates whether a secure element | Yes |
| | associated with a mobile wallet has | |
| | changed | |
| SIM ID | Unique identifier of a SIM card | Yes |
| | (e.g., ICCID) | |
| App Name | Name of an application | Yes |
| Wallet | Name of a provider or issuer of a | Yes |
| Issuer Name | mobile wallet | |
| E-mail ID | User-inputted e-mail address that is | Yes |
| | coupled with a user-inputted pass- | |
| | word, and associated with a mobile | |
| | wallet | |
| Phone_Changed | Indicates whether a mobile device | Yes |
| | associated with a mobile wallet has | |
| | changed | |
| App Version | Version of application | Yes |
| Device Token | Token used to push information onto | No |
| | a mobile device | |
| PIN | User-inputted identifier which is | Yes |
| | encoded and associated with a mobile | |
| | wallet | |
| OS Version | Version of operating system of a | Yes |
| | mobile device | |
| MSISDN | User-inputted mobile number of a | No |
| | mobile device | |
| Device Model | Model of a mobile device | Yes |
| SIM_ID_Changed | Indicates whether a SIM ID asso- | Yes |
| | ciated with a mobile wallet has | |
| | changed | |
| SE Form Factor | Form factor of a secure element | Yes |
| | (e.g., UICC, MicroSD) | |
| Wallet_ID_Changed | Indicates whether a mobile wallet | Yes |
| | was uninstalled and reinstalled on | |
| | a same secure element | |

The mobile wallet 101 transmits the activation request to the server 105, including information as indicated in Table 2, to activate the mobile wallet 101 on the mobile device 102.

At block 302, the server 105 processes the activation request received from the mobile wallet 101. In particular, the server 105 first determines whether duplicates of the e-mail ID and/or SE ID received in the activation request exist in the server 105. If a determination is made that duplicates of the e-mail ID and/or SE ID are stored in the server 105, the server 105 provides an indication to the user 103, such as by transmitting an error message to the mobile device 102.

If a determination is made that a duplicate of the SE ID received in the request exists in the server 105, the mobile wallet 101 determines whether a mobile wallet status associated with the duplicate SE ID is “MDN VALIDATION PENDING.” That is, the server 105 determines whether a mobile wallet associated with the received SE ID is pending validation. If a determination is made that a mobile wallet associated with the SE ID is pending validation, the server 105 marks the mobile wallet as “unused”, erases the e-mail ID associated with the mobile wallet, and/or stores information indicating that that the user associated with the mobile wallet is inactive.

At block 303, the server 105 generates a mobile wallet ID and a correlation ID associated with the mobile wallet 101. The server 105 transmits a request to the ESB 106 to activate the mobile wallet 101. In turn, the ESB 106 creates and stores a mobile wallet record (discussed above in further detail, with reference to FIG. 2) for the mobile wallet 101, and then sets the state of the mobile wallet 101 in the mobile wallet record to “MDN VALIDATION PENDING.” The ESB 106 also creates and stores a consumer profile associated with the mobile wallet 101, and sets the status of the consumer profile to “INACTIVE.” The consumer profile includes information associated with the user 103, such as the e-mail ID.

Similarly, the server 105 creates and stores a mobile wallet record and a consumer profile. Additionally, the server 105 creates and stores a handset record including information of the mobile device 102. The ESB 106 then enters a state of hibernation until it receives a message from the server 105 or short message service (SMS) message.

In turn, the server 105 transmits the mobile wallet ID and a set of predetermined mobile wallet default settings to the mobile wallet 101.

At block 304, the mobile wallet 101 receives the mobile wallet ID and default settings from the server 105 and creates a mobile wallet record in the mobile wallet 101 using the received data. The mobile wallet 101 transmits a mobile-originated (i.e., originated from the mobile device 102) message to the ESB 106. If the mobile wallet 101 determines that the message was successfully sent to the ESB 106, the mobile wallet 101 provides an indication to the user 103 that the mobile wallet 101 is pending activation. This indication is provided to the user, for example, by displaying an error message on the mobile device 102. The mobile wallet 101 also provides an acknowledgment to the server 105, indicating that the activation request was completed. Alternatively, if the mobile wallet determines that the message was not successfully sent to the ESB 106, the mobile wallet attempts to transmit the message a predetermined number of times. If the message is not successfully sent to the ESB 106 after a predetermined number of attempts, the mobile wallet 101 provides an indication to the user 103, such as by displaying an error message on the mobile device 102. The user 103 may also be prompted to restart the mobile wallet activation process.

Further, at block 304, the ESB 106 (which is in a state of hibernation) receives the message from the mobile wallet 101. The ESB 106 then instructs the server 105 to update the mobile wallet record, consumer profile and handset instance created for the mobile wallet 101 with the information received in the activation request. The server 105 also updates the status of the mobile wallet 101 to “ACTIVATION PENDING” to indicate that the mobile wallet 101 is pending activation.

The ESB 106 validates the MSISDN associated with the mobile wallet 101. The ESB 106 validates the MSISDN directly via the MNO corresponding to the MSISDN. In turn, the ESB 106 registers the mobile wallet 101 with an SMS aggregator system. An SMS aggregator system provides connectivity to a variety of systems or devices on a mobile network, and manages the sending and receiving of SMS messages. The ESB 106 instructs a TSM (e.g., TSM 107) to create a mobile wallet record for the mobile wallet 101, and to install, personalize and activate applets and/or applications (e.g., WCAp) in the secure element 104. U.S. patent application Ser. Nos. 13/653,160 and 13/653,145, respectively entitled “Systems, Methods, and Computer Program Products for Interfacing Multiple Service Provider Trusted Service Managers and Secure Elements,” and “Systems, Methods, and Computer Program Products for Managing Secure Elements”, which are incorporated herein by reference in their entirety, describe installing and/or “instantiating,” personalizing, and activating applets and/or applications on a secure element.

At block 305, the ESB 106 provides a notification to the TSM 107, indicating that the mobile wallet 101 has been activated. The ESB 106 instructs the server 105 to update the status of the mobile wallet 101 to “ACTIVE”, and the ESB 106 then publishes information indicating that the mobile wallet 101 has been activated. In turn, the ESB 106 provides an indication to the user 103 that the mobile wallet 101 has been activated. This indication is provided to the user, for example, via e-mail, SMS, and/or the like.

In turn, the user 103 may open the activated mobile wallet 101 using, for example, the interface of the mobile device 102.

In an alternative embodiment, the ESB 106 transmits an SMS to the mobile wallet 101 on the mobile device 102, including an activation link, mobile wallet ID and correlation ID. The mobile wallet 101 receives the SMS, and once the activation link has been selected, the mobile wallet 101 transmits a request to the server 101 including the mobile wallet ID and correlation ID. In turn, the server 105 determines whether the mobile wallet ID and correlation ID are valid (e.g., they match, as expected). If the server 105 determines that the mobile wallet ID and/or correlation ID are not valid, it provides an indication to the user 103 via, for example, the user interface of the mobile device 102. If the server 105 determines that the mobile wallet ID and the correlation ID are valid, it communicates a message informing the ESB 106 to continue with the mobile wallet activation process.

### C. Restoring a Mobile Wallet on a Mobile Device

FIG. 4 is a flowchart illustrating a process 400 for restoring a mobile wallet on a mobile device according to an exemplary embodiment.

At block 401, the mobile wallet 101 validates information associated with the mobile wallet 101. In particular, at block 401, the mobile wallet 101 determines whether the SE ID of the secure element 104 matches the SE ID associated with the mobile wallet 101 (i.e., the SE ID stored in the mobile wallet 101). If a determination is made that the SE ID of the secure element 104 and the SE ID associated with the mobile wallet 101 match, the mobile wallet 101 obtains a PIN (e.g., mobile wallet PIN). The PIN is obtained, for example, from the user 103 via the interface of the mobile device 102. Once the PIN is obtained, the mobile wallet 101 transmits it to the secure element 104 to determine whether the obtained PIN is valid (i.e., whether the obtained PIN matches a PIN stored on the secure element 104). If the secure element 104 determines that the obtained PIN is not valid, the mobile wallet 101 re-obtains the PIN, and the secure element determines whether the re-obtained PIN is valid. The secure element 104 may become locked if validation of the PIN fails a predetermined number of times.

If a determination is made that the SE ID of the secure element 104 and the SE ID associated with the mobile wallet 101 do not match, the mobile wallet 101 collects account credentials, such as a username and password. The account credentials are collected, for example, from the user 103 via the interface of the mobile device 102. The mobile wallet 101 transmits the account credentials to the server 105.

In turn, the server 105 validates the account credentials received from the mobile wallet 101, and determines whether the mobile wallet 101 is in a terminated, change detected, or suspended state. That is, the server 105 determines whether the status of the mobile wallet 101 is “TERMINATED,” CHANGE DETECTED,” or “SUSPENDED.” If a determination is made that the account credentials are not valid, and/or that the mobile wallet 101 is not in a terminated, change detected, or suspended state, the server 105 provides an indication to the user 103, such as by displaying an error message on the display of the mobile device 102. An error message is transmitted to the user via, for example, e-mail or SMS.

If a determination is made that the account credentials are valid, and that the status of the mobile wallet 101 is not in a terminated, change detected, or suspended state, the mobile wallet 101 transmits mobile device attributes of the mobile device 102 to the server 105. The mobile device attributes may include a SIM ID, SE ID, device ID, manufacturer model, MNO name, mobile wallet issuer name, mobile wallet version, network type, MSISDN, device token, secure element form factor, and/or operation system version. The mobile device attributes transmitted to the server 105 may also include the attributes listed in Table 2.

The server 105 receives the mobile device attributes and validates at least a portion of the mobile device attributes, for example, to determine whether the mobile wallet 101 can be restored on the mobile device 102. In particular, the server 105 may validate the operating system version, secure element form factor, and MNO name. This validation may include checking whether the operating system version, secure element form factor, and MNO name are included in a predetermined set of valid values.

If a determination is made that the operating system version, secure element form factor, and/or MNO name are not valid, the server 105 provides an indication to the user 103, such as by displaying an error message on the display of the mobile device 102. Alternatively, if a determination is made that the operating system version, secure element form factor, and MNO are valid, the mobile wallet 101 determines whether the SE ID of the secure element 104 and the SE ID associated with the mobile wallet 101 match. If a determination is made that the SE ID of the secure element 104 and the SE ID associated with the mobile wallet 101 match (i.e., a change is not detected), the mobile wallet 101 logs this information at block 402. The logged information may be transmitted to the server 105.

Alternatively, if a determination is made that the SE ID of the secure element 104 and the SE ID associated with the mobile wallet 101 do not match (i.e., a change is detected), the secure element 104 performs a parity check (discussed above in further detail with reference to FIG. 2).

In turn, the mobile wallet 101 determines whether the wallet ID of the mobile wallet 101 matches the wallet ID stored on the secure element 104. If a determination is made that the wallet ID of the mobile wallet 101 does not match the wallet ID stored on the secure element 104 (i.e., there is a mismatch), the server 105 provides an indication to the user 103, such as by displaying an error message on the display of the mobile device 102.

Alternatively, if a determination is made that the wallet ID of the mobile wallet 101 matches the wallet ID stored on the secure element 104 (i.e., a mismatch is not detected), the mobile wallet 101 logs this information at block 402. The logged information may be transmitted to the server 105.

At block 403, the server 105 transmits profile information of the user 103 to the mobile wallet 101. The profile information may include, for example, a user ID or e-mail ID of the user 103. Upon receiving the profile information, the mobile wallet 101 deletes data associated with the mobile wallet 101 from the mobile device 102. The mobile wallet 101 replaces the deleted profile data with the profile information of user 103, received from the server 105.

At block 404, the mobile wallet 101 processes the change associated with the mobile wallet 101. In particular, at block 404, the mobile wallet 101 retrieves mobile device attributes from the mobile device 102, such as device ID, the SIM ID, and/or the SE ID of the mobile device 102. The mobile wallet 101 transmits the mobile device attributes, along with the wallet ID of the mobile wallet 101 and the MNO ID of the mobile device 102, to the server 105. The mobile wallet 101 determines whether the retrieved mobile device attributes of the mobile device 102 (i.e., the device ID, SIM ID, and/or SE ID) match the mobile device attributes associated with the mobile wallet 101. If a determination is made that the mobile device attributes of the mobile device 102 do not match the mobile device attributes associated with the mobile wallet 101, the mobile wallet 101 transmits a message to a message aggregator system for MSISDN and MNO identification. Further, the mobile wallet 101 provides an indication to the user 103 that the mobile wallet 101 is pending restoration, such as by displaying a message on the display of the mobile device 102.

The server 105, after receiving the mobile device attributes of the mobile device 102 from the mobile wallet 101, creates a temporary record including the received mobile device attributes, MNO ID, and/or MSISDN. Additionally, the server 105 sets the status of the mobile wallet 101 to “CHANGE DETECTED.”

In turn, the server 105 transmits the new mobile device attributes, MNO ID, and/or MSISDN to the ESB 106. Additionally, the server 105 transmits, to the ESB 106, information indicating whether the MNO is eligible and whether the password received from the mobile wallet 101 is valid.

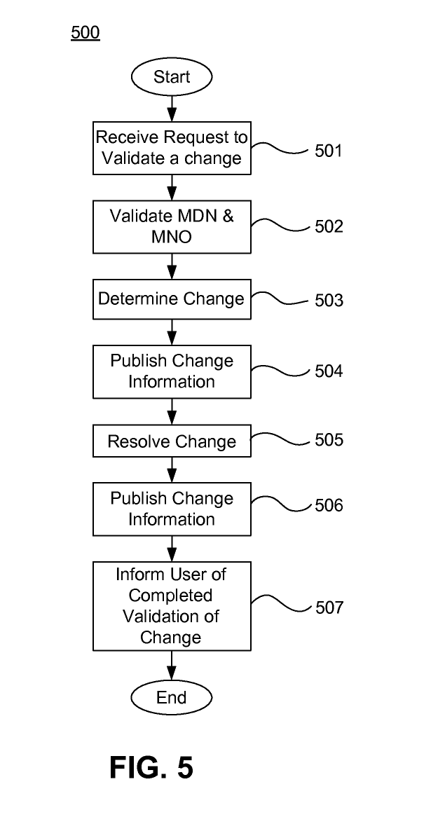

The ESB 106 validates the one or more changes associated with the mobile wallet 101, based on the received mobile device attributes of the mobile device 102. The validation of changes by the ESB 106 is discussed in further detail below with reference to FIG. 5.

In turn, the server 105 updates the mobile wallet record of the mobile wallet 101 with the temporary record, which includes the received mobile device attributes, MNO ID, and/or MSISDN. Further, the server 105 makes payment cards, widgets and messages available for download by the mobile wallet 101.

If the ESB 106 determines, during validation of the one or more changes associated with the mobile wallet 101 (discussed in further detail below with reference to FIG. 5), that the secure element associated with the mobile wallet has changed, the ESB 106 updates the secure element. In particular, the ESB 106 may install and personalize applets and/or applications, and/or activate the WCAp on the secure element 104. Alternatively, if the ESB 106 determines that the secure element associated with the mobile wallet 101 has not changed, the ESB 106 updates the WCAP with the new mobile device attributes. In an alternative embodiment, the ESB 106 may update the secure element 104 by transmitting one or more requests and instructions to the TSM 107.

The ESB 106 publishes information indicating that the mobile wallet 101 is active. In turn, the server 105 updates the status of the mobile wallet to “ACTIVE.” Additionally, the ESB 106 provides an indication to the user 103 that the mobile wallet 101 is active, such as by transmitting a message via e-mail or SMS.

In turn, the user 103 may open the activated mobile wallet 101 using, for example, the interface of the mobile device 102. When the mobile wallet 101 is opened, the mobile wallet 101 collects a PIN, for example, via the interface of the mobile device 102. The mobile wallet 101 validates the PIN, and then synchronizes the mobile wallet 101. In particular, the server 105 determines the new and/or updated content associated with the mobile wallet 101, and reinstalls the mobile wallet 101 on the mobile device 102 using the new and/or updated content. In turn, the updated and active mobile wallet 101 can be opened on the mobile device 102.

D. Validating Changes Associated with a Mobile Wallet

FIG. 5 is a flowchart illustrating a process 500 for validating changes associated with a mobile wallet according to an exemplary embodiment.

At block 501, the ESB 106 receives a request to validate a change associated with the mobile wallet 101. The request is received from the server 105, and the validation is based on information received in the validation request (e.g., mobile device attributes, MNO ID, MSISDN).

At block 502, the ESB 106 validates the MSISDN and MNO associated with the mobile wallet 101. The MSISDN and MNO may be validated via the user 103 or with a messaging aggregator system. For example, the ESB 106 can send a message (e.g., SMS) to the user 103 or to the messaging aggregator system, and wait for a response indicating that the MSISDN and/or MNO are valid. If the ESB 106 determines that the MSISDN is not valid, the ESB 106 terminates the validation process. Alternatively, if the MSISDN is valid the ESB 106 updates the status of the mobile wallet 101 to “CHANGE DETECTED” and determines whether the MNO is eligible to support a mobile wallet. If the ESB 106 determines that the MNO is not eligible, the ESB 106 terminates the validation process.

In turn, the ESB 106 determines whether the MSISDN is assigned to a mobile wallet different than mobile wallet 101. If the MSISDN is assigned to a mobile wallet different than mobile wallet 101, the ESB 106 terminates the validation process. Alternatively, if the MSISDN is not assigned to mobile wallet different than mobile wallet 101, the ESB 106 determines whether the MSISDN is eligible to support a mobile wallet. If a determination is made that the MSISDN is not eligible to support a mobile wallet, the ESB 106 terminates the validation process.

If the ESB 106 determines that the MSISDN is eligible to support a mobile wallet, the ESB 106 determines, at block 503, whether the MNO, MSISDN, secure element, or handset (i.e., mobile device) has changed based on the information received in the request (i.e., mobile device attributes, MNO ID, MSISDN). If the ESB determines, at block 503, that the MNO, MSISDN, secure element, or handset have changed, the ESB 106 publishes information, at block 504, indicating that a change has been detected.

At block 505, the ESB 106 resolves the change. In particular, resolving a change may include determining whether the MNO, MSISDN, secure element, or SIM ID have changed, and/or updating the secure element, as needed based on the particular change.

If a determination is made that the MNO has changed, the ESB 106 publishes information that a subscription has been terminated, and subsequently, that a subscription has been started. The ESB 106 provides an indication to the user 103 that the MNO has changed. Additionally, if a determination is made that the MSISDN has changed, the ESB 106 provides an indication to the user 103 that the MSISDN has changed. If a determination is made that the mobile device has changed, the ESB 106 provides an indication to the user 103 that the mobile device has changed.

Further, if a determination is made that the secure element has changed, the ESB 106 provides an indication to the user 103 that the secure element has changed. The ESB 106 then determines whether the secure element, which has changed, is new or if it will be reused (i.e., the secure element is not new). If a determination is made that the secure element is not new, the ESB 106 erases (i.e., wipes) data in the secure element. In turn, the ESB 106 installs and/or updates applets and/or applications, and sets up (i.e., restores) payment and/or service accounts, which were previously associated with the mobile wallet account corresponding to the mobile wallet 101, on the secure element 104. Alternatively, if a determination is made that the secure element has not changed, the ESB 106 determines whether the mobile device has changed.

If a determination is made that the mobile device has changed, the ESB 106 installs and/or updates applets and/or applications, and sets up (i.e., restores) payment and/or service accounts, which were previously associated with the mobile wallet account corresponding to the mobile wallet 101, on the secure element 104. If a determination is made that the SIM ID has changed, the ESB 106 installs and/or updates applications on the secure element 104.

At block 506, the ESB 106 updates the status of the mobile wallet 101 to “WALLET ACTIVATED” and publishes information indicating that a change in the mobile wallet 101 has been validated.

In turn, at block 507, the ESB 106 provides an indication to the user 103 that the mobile wallet 101 is active, such as by transmitting a message via e-mail or SMS. The ESB 106 may also inform the user 103 that the mobile wallet 101 can be opened on the mobile device 102 in order to update (i.e., synchronize) the mobile wallet 101 on the mobile device 102, as discussed in above with reference to FIG. 4.

In an alternative embodiment, the ESB 106 communicates with a mobile wallet (e.g., mobile wallet 101), TSM (e.g., TSM 107), and/or MNO (e.g., MNO 108), in order to validate a change. For example, the ESB 106 may transmit requests (e.g., install application, update status, publish information) to the mobile wallet 101, TSM 107 or MNO 108, for completing a validation process.

### E. Computer Readable Medium Implementation

The present invention (e.g., system 100, processes 200-500, or any part(s) or function(s) thereof) can be implemented using hardware, software, or a combination thereof, and can be implemented in one or more mobile device or other processing systems. To the extent that manipulations performed by the present invention were referred to in terms of human operation, no such capability of a human operator is necessary, or desirable in most cases, in any of the operations described herein which form part of the present invention. Rather, the operations described herein are machine operations. Useful machines for performing the operations of the present invention include mobile phones, smartphones, personal digital assistants (PDAs) or similar devices.

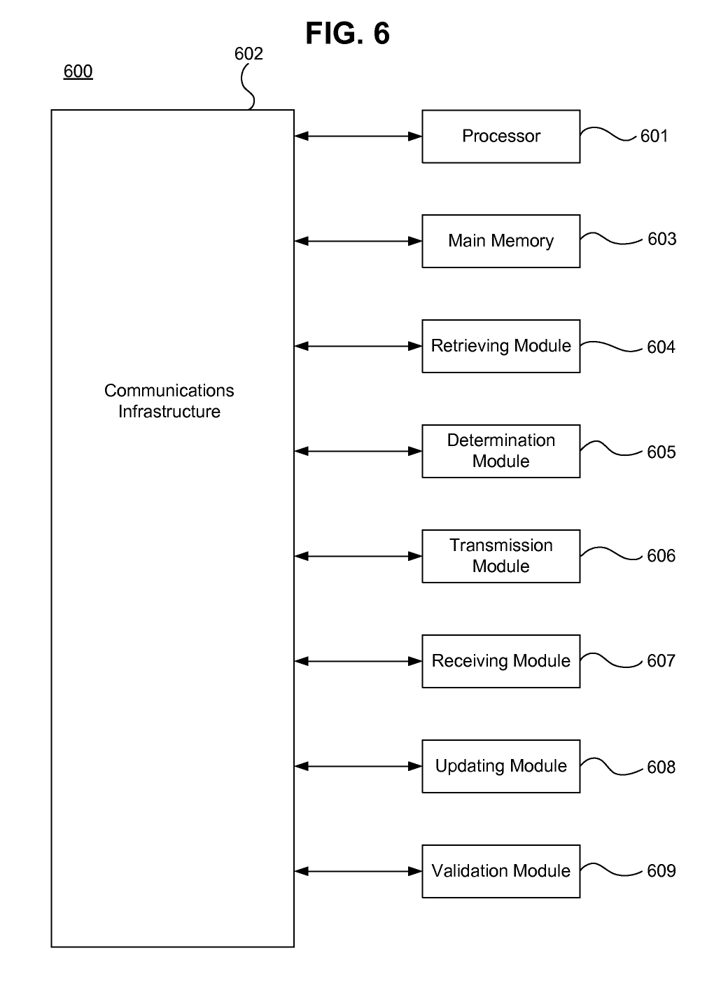

In one embodiment, the invention is directed toward one or more systems capable of carrying out the functionality described herein. An example of a system 600 is shown in FIG. 6.

The system 600 includes one or more processors, such as processor 601. The processor 601 is connected to a communication infrastructure 602 (e.g., communication bus, network). Various embodiments are described in terms of this exemplary system. After reading this description, it will become more apparent to a person skilled in the relevant art(s) how to implement the invention using other systems and/or architectures.

The system 600 also includes a main memory 603, which may be a non-volatile memory, or the like.

The system 600 also includes a retrieving module 604 for retrieving data from the main memory 603. Retrieving data is discussed in further detail above with reference to FIGS. 2-5.

The system 600 also includes a determination module 605 for determining, for example, whether a change has occurred. Determining, for example, whether a change has occurred is discussed in further detail above with reference to FIGS. 2-5.

The system 600 also includes a transmission module 606 for transmitting data, such as a request, over a communications network. Transmitting data is discussed in further detail above with reference to FIGS. 2-5.

The system 600 also includes a receiving module 607 for receiving data, for example, over a communications network. Receiving data is discussed in further detail above with reference to FIGS. 2-5.

The system 600 also includes an updating module 608 for updating, for example, the main memory 603. Updating a memory (e.g., main memory 603) is discussed in further detail above with reference to FIGS. 2-5.

The system 600 also includes a validation module 609 for validating data. Validating data is discussed in further detail above with reference to FIGS. 2-5.

Each of modules 604-609 may be implemented using hardware, software or a combination of the two.

The example embodiments described above such as, for example, the systems and procedures depicted in or discussed in connection with FIGS. 1 to 5, or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a non-transitory storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the non-transitory computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for detecting and managing changes, comprising:
at least one memory operable to store current mobile wallet data, including current mobile device attributes; and
a processor coupled to the at least one memory, the processor being operable to:
retrieve the current mobile wallet data from the at least one memory;
retrieve new mobile device attributes;
determine whether a change has occurred based on a comparison of the current mobile wallet data and the new mobile device attributes;
transmit, to a server on a communications network, a request to process the change;
receive, over the communications network, in response to the request, update data; and
update the current mobile wallet data in the at least one memory with the update data.

2. The system of claim 1, further comprising a secure element operable to perform a parity check between the current mobile wallet data and the new mobile device attributes.

3. The system of claim 1, further comprising a secure element including a secure element memory, wherein the processor is further operable to update the secure element memory with the update data.

4. The system of claim 1, wherein the request includes the new mobile device attributes.

5. The system of claim 1, wherein the processor is further operable to classify the change from a plurality of change types.

6. The system of claim 1, wherein the new mobile device attributes include a device ID, a subscriber identity module (SIM) ID, and a secure element (SE) ID.

7. The system of claim 1, wherein the processor is further operable to construct a log of the change based on a comparison of the current mobile wallet data and the new mobile device attributes.

8. A method for detecting and managing changes, comprising steps of:
storing, in at least one memory, current mobile wallet data, including current mobile device attributes;
retrieving the current mobile wallet data from the at least one memory;
retrieving new mobile device attributes;
determining whether a change has occurred based on a comparison of the current mobile wallet data and new second mobile device attributes;
transmitting, to a server on a communications network, a request to process the change;
receiving, over the communications network, in response to the request, update data; and
updating the current mobile wallet data in the at least one memory with the update data.

9. The method of claim 8, wherein a secure element performs a parity check between the current mobile wallet data and the new mobile device attributes.

10. The method of claim 8, further comprising a step of updating a secure element including a secure element memory with the update data.

11. The method of claim 8, wherein the request includes the new mobile device attributes.

12. The method of claim 8, further comprising a step of classifying the change from a plurality of change types.

13. The method of claim 8, wherein the new mobile device attributes includes a device ID, a SIM ID, and a SE ID.

14. The method of claim 8, further comprising a step of constructing a log of the change based on a comparison of the current mobile wallet data and the new mobile device attributes.

15. A non-transitory computer-readable medium having stored thereon sequences of instructions for causing one or more processors to:
store, in at least one memory, current mobile wallet data, including current mobile device attributes;
retrieve the current mobile wallet data from the at least one memory;
retrieve new mobile device attributes;
determine whether a change has occurred based on a comparison of the current mobile wallet data and the new mobile device attributes;
transmit, to a server on a communications network, a request to process the change;
receive, over the communications network, in response to the request, update data; and
update the current mobile wallet data in the at least one memory with the update data.

16. The computer-readable medium of claim 15, wherein a secure element performs a parity check between the current wallet data and the new mobile device attributes.

17. The computer-readable medium of claim 15, wherein the sequence of instructions further cause the one or more processors to:
update a secure element including a secure element memory with the update data.

18. The computer-readable medium of claim 15, wherein the request includes the new mobile device attributes.

19. The computer-readable medium of claim 15, wherein the sequence of instructions further cause the one or more processors to:
classify the change from a plurality of change types.

20. The computer-readable medium of claim 15, wherein the new mobile device attributes include a device ID, a SIM ID, and a SE ID.

21. The computer-readable medium of claim 15, wherein the sequence of instructions further cause the one or more processors to:
construct a log of the change based on a comparison of the current mobile wallet data and the new mobile device attributes.

22. A system for detecting and managing changes, comprising:
at least one memory operable to store current mobile wallet data, including current mobile device attributes;
a processor, coupled to the at least one memory, the processor being operable to:
receive, over a communications network, a request to process a change, including new mobile device attributes;
validate at least a portion of the new mobile device attributes;
determine a change based on a comparison between the new mobile device attributes and the current mobile device attributes,
determine, based on the change, update data; and
transmit an update request, including the update data, to a mobile device over a communications network.

23. The system of claim 22, wherein the new mobile device attributes include a device ID, a SIM ID, and a SE ID.

24. The system of claim 22, wherein the update data includes at least one of application data, account information, and at least a portion of the new mobile device attributes.

25. The system of claim 22, further operable to transmit information indicating the status of the request to process a change.

26. A method for detecting and managing changes, comprising steps of:
receiving, over a communications network, a request to process a change, including new mobile device attributes;
validating at least a portion of the new mobile device attributes;
determining a change based on a comparison between the new mobile device attributes and current mobile device attributes, the current mobile device attributes being stored on at least one memory;
determining, based on the change, update data; and
transmitting an update request, including the update data, to a mobile device over a communications network.

27. The method of claim 26, wherein the new mobile device attributes include a device ID, a SIM ID, and a SE ID.

28. The method of claim 26, wherein the update data includes at least one of application data, account information, and at least a portion of the new mobile device attributes.

29. The method of claim 26, further comprising a step of transmitting information indicating the status of the request to process a change.

30. A non-transitory computer-readable medium having stored thereon sequences of instructions for causing one or more processors to:
receive, over a communications network, a request to process a change, including new mobile device attributes;
validate at least a portion of the new mobile device attributes;
determine a change based on a comparison between the new mobile device attributes and current mobile device attributes, the current mobile device attributes being stored on at least one memory;
determine, based on the change, update data; and
transmit an update request, including the update data, to a mobile device over a communications network.

31. The computer-readable medium of claim 30, wherein the new mobile device attributes include a device ID, a SIM ID, and a SE ID.

32. The computer-readable medium of claim 30, wherein the update data includes at least one of application data, account information, and at least a portion of the new mobile device attributes.

33. The computer-readable medium of claim 30, wherein the sequence of instructions further cause the one or more processors to:
transmit information indicating the status of the request to process a change.
